(19) United States
(12) Patent Application Publication
(10) Pub. No.: US 2008/0254747 A1
(43) Pub. Date: Oct. 16, 2008

(54) HANDHELD DEVICE AND COMMUNICATION METHOD

(75) Inventors: PIN-FENG FU, Shenzhen (CN); SHIH-FANG WONG, Tu-Cheng (TW); ZHAN-WU LI, Shenzhen (CN); CHUN-HUA LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/967,120

(22) Filed: Dec. 29, 2007

(30) Foreign Application Priority Data
Apr. 16, 2007 (CN) 200710200461.3

(51) Int. Cl. H04B 7/00; G10L 15/26

(52) U.S. Cl. 455/66.1; 704/235; 704/E15.043; 341/22; 455/103

(57) ABSTRACT

A handheld device includes a first wireless transceiver and a second wireless transceiver. The first wireless transceiver is used for implementing normal communication. The second wireless transceiver is used for abnormal conditions. When the first wireless transceiver is used, the second wireless transceiver is disabled for saving electrical energy. The second wireless transceiver uses a different frequency from the first wireless transceiver. The second wireless transceiver can be used to establish a wireless link directly between the handheld device and a rescuing center without using base transceiver stations.

### BACKGROUND

1. Field of the Invention

The present invention generally relates to handheld devices, and particularly, to a handheld device and a communication method thereof.

2. Description of Related Art

Handheld devices such as mobile phones and the like are very common. Such devices allow users to communicate with each other. However, users of such devices must be within a service range of a communication network. Various communication standards such as CDMA, GPRS, GSM, etc., are adopted to communicate with the providing network. For example, a handheld device may be wirelessly connected to a base transceiver station (BST) for communication using a network standard.

However, the wireless connection using the conventional standard network may not be easily established when the network traffic is too heavy, or out of service due to faulty equipment or may be inoperative due to other circumstances, such as earthquake, hurricanes, or other natural disasters. Thus, the BST would not be able to establish a wireless connection to route radio frequency waves for communication. Under these circumstances, people would not be able to signal for help using the current handheld devices.

Therefore, what is needed in the industry is to provide a handheld device that can be used during emergencies, when the conventional standard network is not able to establish wireless connection, and a communication method for using the handheld device.

### SUMMARY

Accordingly, a handheld device is provided. The handheld device includes a first wireless transceiver using a first frequency, and a second wireless transceiver using a second frequency for communication. The first frequency is higher than the second frequency. In normal conditions, people use the first wireless transceiver or the second wireless transceiver to communicate. When the first wireless transceiver is not usable, the second wireless transceiver can be used. There is also provided a communication method for implementing the handheld device as described above.

### BRIEF DESCRIPTION OF THE DRAWINGS

FIG. 1 is a general, schematic view of a handheld device.

FIG. 2 is a block diagram of the handheld device.

FIG. 3 is a more detailed block diagram of the handheld device.

FIG. 4 is a flow chart for implementing a communication method of the handheld device.

FIG. 5 is a detailed flow chart of implementing an action in FIG. 4.

### DETAILED DESCRIPTION

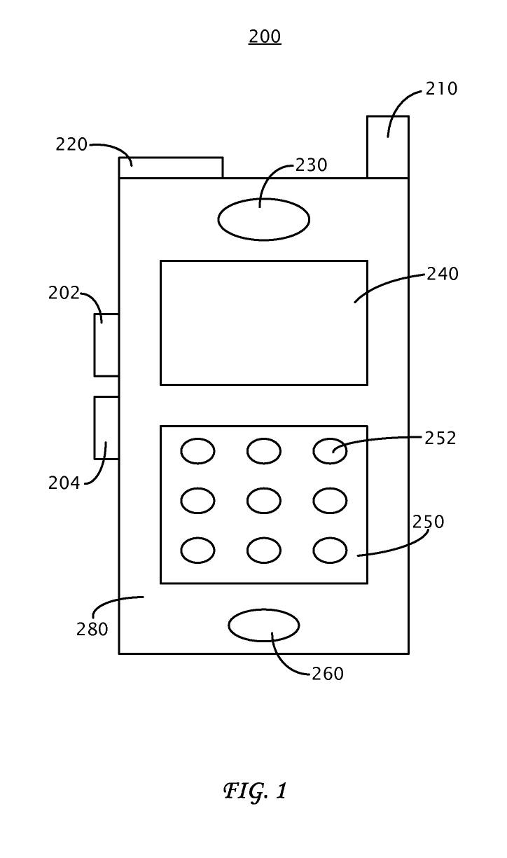

Referring to FIG. 1, a handheld device 200 is provided. The handheld device 200 includes a body 280, a first antenna 210, a second antenna 220, a speaker 230, a display screen 240, a keypad 250, a microphone 260, and function keys 202, 204. The handheld device 200 may be any type of wireless communications device capable of communicating using the first antenna 210 and/or the second antenna 220. For example, the handheld device 200 may be a cellular phone or personal a digital assistant (PDA). The first antenna 210 and the second antenna 220 are arranged at an end portion of the body 280. The function keys 202, 204 are arranged at a side portion of the body 280. The inside of the body 208 is accommodated with electrical circuits (not shown) for processing data and executing software programs. It should be noted that the handheld device 200 may include additional features known in the art that are not illustrated. For example, the handheld device 200 may include a camera module (not shown) for capturing images.

The first antenna 210 has a length corresponding to wavelengths commonly used by communication standards such as CDMA, GSM, and so on. The first antenna 210 transmits and receives first radio frequency (RF) waves conveyed with communicating data. A typical frequency of the first RF waves may be 900 MHz and 1800 MHz. The second antenna 220 has a length corresponding to wavelengths used in second RF waves. The second RF waves have frequencies ranging from 1 KHz to 1000 KHz. The second antenna 220 transmits and receives the second RF waves. As the frequency of the second RF waves is less than that of the first RF signals, i.e., the wavelength of the second RF waves are longer than that of the first RF waves, the second RF waves can propagate further than the first RF waves with less energy attenuation. Therefore, the handheld device 200 may be used to communicate directly with a rescue center, for example, via the second RF waves sending a request for aid when it is not possible for connecting the handheld device 200 to the BTS via the first RF waves.

The display screen 240 is a liquid crystal display (LCD) configured for displaying text information and graphical user interfaces (GUIs) (not shown) items etc. The keypad 250 includes a plurality of keys 252 for selecting icons of the GUIs to actuate the handheld device 200 to perform specific functions, for example, to play songs and video programs. The keypad 250 may be replaced by other input devices such as a touch panel, a joystick, and so on.

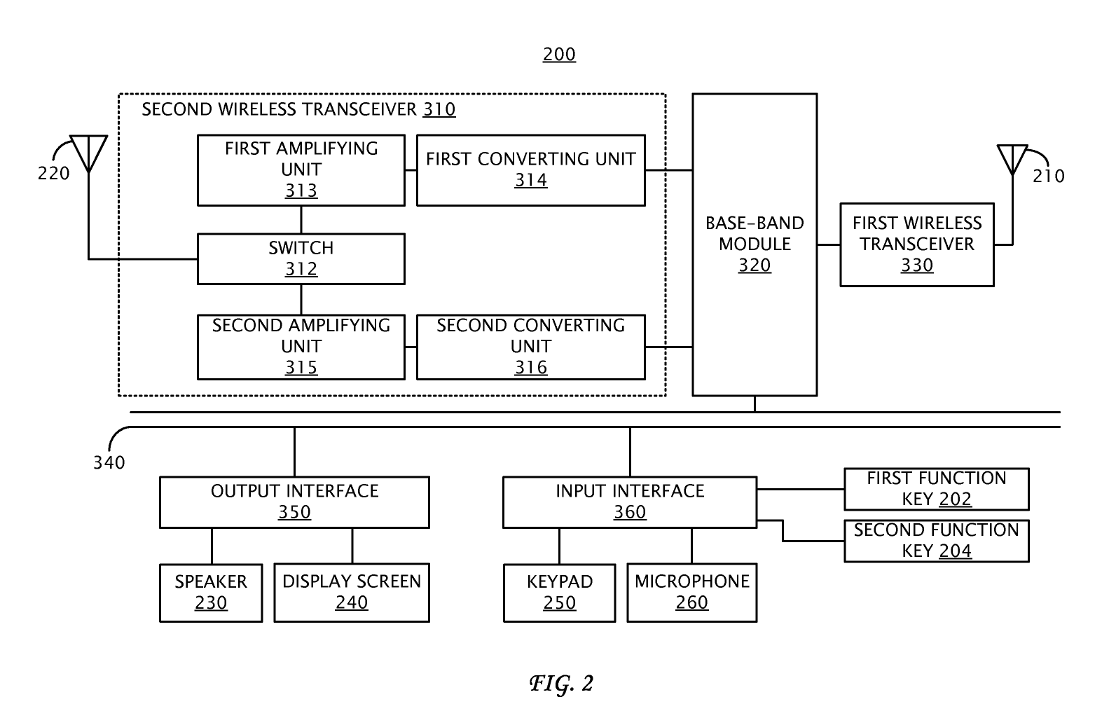

Referring to FIG. 2, the handheld device 200 further includes a first wireless transceiver 330, a second wireless transceiver 310, a base-band module 320, a data bus 340, an output interface 350, and an input interface 360. The first wireless transceiver 330 is electrically connected to the first antenna 210 for transmitting and receiving the first RF waves. The second wireless transceiver 310 is electrically connected to the second antenna 220 for transmitting and receiving the second RF waves. The base-band module 320 is electrically connected to the first wireless transceiver 330 and the second wireless transceiver 310.

The output interface 350 and the input interface 360 are coupled to the base-band module 320 by the data bus 340. The output interface 350 is connected to the speaker 230 and the display screen 240 for outputting audio and displaying text respectively. The input interface 360 is connected to the keypad 250, the microphone 260, the first function key 202, and the second function key 204 for inputting information.

Under normal conditions, that is, when the BST is available, the base-band module 320 can communicate with the BST via the first RF waves. The second wireless transceiver 310 is disabled by the base-band module 320 for saving electrical energy.

When the BST is not available, i.e. the wireless connection of the CDMA or the GSM service network is not detected by the base-band module 320. The second wireless transceiver 310 is enabled by the base-band module 320. The second wireless transceiver 310 receives and transmits the second RF waves to communicate with other handheld devices or the rescue center via the second antenna 220.

The second wireless transceiver 310 includes a switching unit 312, a first amplifying unit 313, a first converting unit 314, a second amplifying unit 315, and a second converting unit 316. The switching unit 312 is electrically connected to the antenna 220, and actuated to connect with the first amplifying unit 313 or the second amplifying unit 315. The first amplifying unit 313 is electrically connected to the first converting unit 314. The second amplifying unit 315 is electrically connected to the second converting unit 316. The first converting unit 314 and the second converting unit 316 are electrically connected to the base-band module 320.

When the switching unit 312 is actuated to electrically connect the antenna 220 to the first amplifying unit 313, the second RF waves are received by the second antenna 220. The second RF waves are down-converted to the second RF signals by the second antenna 220. The second RF signals are amplified by the first amplifying unit 313, thereby yielding amplified second RF signals. The amplified second RF signals are then demodulated and digitized by the first converting unit 314 and yielding second baseband signals. The second baseband signals are transmitted to the base-band module 320 for further processing.

When the switching unit 312 is actuated to electrically connect the second antenna 220 and the second amplifying unit 315, the base-band module 320 sends the second baseband signals produced from voices or messages to the second converting unit 316. The second baseband signals are modulated by the second converting unit 316 and amplified by the second amplifying unit 315, thereby yielding amplified second RF signals. The amplified second RF signals are up-converted to the second RF waves and sent out by the second antenna 220.

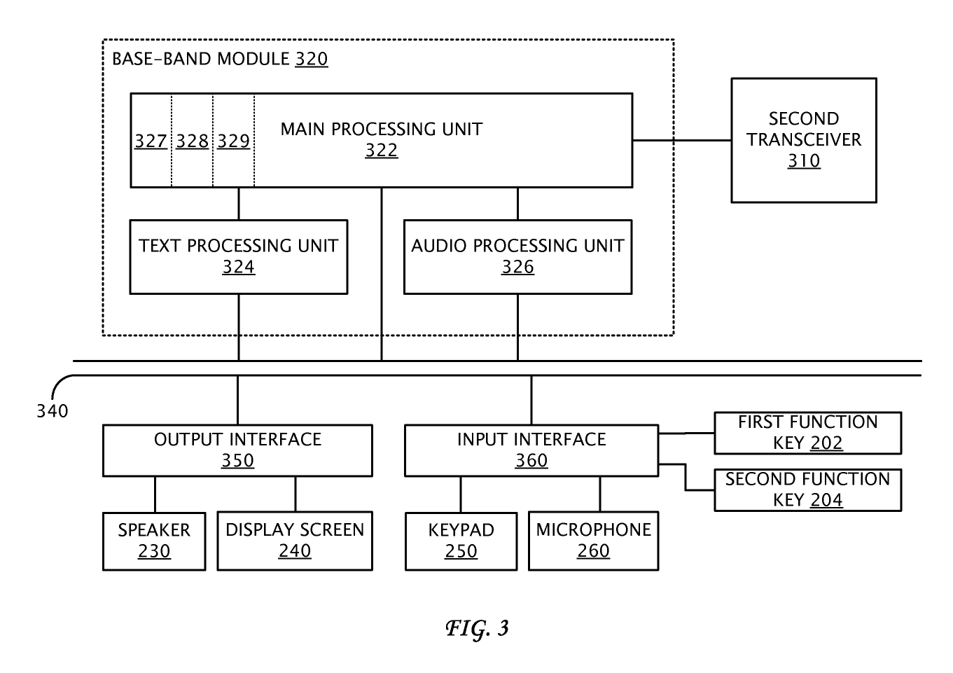

Referring also to FIG. 3, the base-band module 320 includes a main processing unit 322, a text processing unit 324, and an audio processing unit 326. The text processing unit 324 is electrically connected to the main processing unit 322 and the data bus 340. The audio processing unit 326 is electrically connected to the main processing unit 322 and the data bus 340. The handheld device 200 can be used for converting many kinds of user information, such as audio input of voices, text information, etc.

In one embodiment, the microphone 260 is used for audio input, for example “Help me, I'm lost in the desert”. The audio input is converted into analog audio signals by the microphone 260. The analog audio signals are transferred to the audio processing unit 326 via the input interface 360 and the data bus 340. The analog audio signals are then digitized by the audio processing unit 326 to yield digital audio signals. The digital audio signals are sent to the main processing unit 322 and converted to second baseband signals, for example, Morse code signals, according to a first table stored in the first memory area 327 of the main processing unit 322. The second baseband signals are received by the second wireless transceiver 310, converted to the second RF signals, and transmitted by the second antenna 220 after modulation and amplification, etc.

Alternatively, the main processing unit 322 may convert the digital audio signals to digital text signals according to a second table stored in a second memory area 328 of the main processing unit 322. The text processing unit 324 converts the digital text signals to text. The text is displayed on the display screen 240 via the data bus 340 and the output interface 350. The user can check the displayed text to confirm if the audio input has been correctly converted by the main processing unit 322.

In another embodiment, the keypad 250 is used to input text. The text is transferred to the text processing unit 324 via the input interface 360 and the data bus 340. The text is converted to digital text signals by the text processing unit 324. The digital text signals are converted into the second baseband signals by the main processing unit 322 according to a third table stored in a third memory area 329 of the main processing unit 322. The second baseband signals are received by the second wireless transceiver 310, then are up-converted to the second RF signals and are transmitted by the second antenna 220 after modulation and amplification, etc.

Alternatively, the digital text signals are converted into digital audio signals by the main processing unit 322 according to the second table stored in the second memory area 328 of the main processing unit 322. The digital audio signals are converted to analog audio signals by the audio processing unit 324. The analog audio signals are received by the speaker 230 via the data bus 340 and the output interface 350. The speaker 230 outputs sound accordingly. The user can listen to the sounds output from the speaker 230 to confirm if the text is appropriately input from the keypad 250 or appropriately converted by the main processing unit 322. If the sounds are not correctly output, the user may repeat inputting the text by the keypad 250 until the speaker 250 outputs the right sounds.

In another embodiment, the user may use the first function key 202 and the second function key 204 to input the digital code signals, such as the Morse Code directly to the main processing unit 322. An exemplary Morse Code table is shown as below, where the alphabetical letters and the numbers are represented by corresponding Morse Codes.

Morse Code for letters

| Letters | Morse Code |
|---|---|
| A | • — |
| B | — • • • |
| C | — • — • |
| D | — • • |
| E | • |
| F | • • — • |
| G | — — • • |
| H | • • • • |
| I | • • |
| J | • — — — |
| K | — • — |
| L | • — • • |
| M | — — |
| N | — • |
| O | — — — |
| P | • — — • |
| Q | — — • — |
| R | • — • |
| S | • • • |
| T | — |
| U | • • — |
| V | • • • — |
| W | • — — |
| X | — • • — |
| Y | — • — — |
| Z | — — • • |

Morse Code for numbers

| Numbers | Morse Code |
|---|---|
| 1 | • — — — |
| 2 | • • — — — |
| 3 | • • • — — |
| 4 | • • • • — |
| 5 | • • • • • |
| 6 | — • • • • |
| 7 | — — • • • |
| 8 | — — — • • |
| 9 | — — — — • |
| 0 | — — — — — |

The user presses the function key 202 to enter dots and the function key 204 to enter dashes. The user may be in a dangerous situation, for example, in a sea disaster far from land. The user may use the function keys 202, 204 to input an “SOS” Morse code signal, which is represented by “- - -”. The Morse code signals are transferred to the main processing unit 322 via the input interface 360 and the data bus 340, and the second baseband signals produced by the main processing unit 322 are transmitted to the second transceiver 310. The second baseband signals are received by the second wireless transceiver 310, then are converted to the second RF signals, and transmitted by the second antenna 220 after modulation and amplification, etc.

The corresponding text may be displayed on the display screen 240 and/or the corresponding sounds may be output from the speaker 230. If the corresponding text is displayed on the display screen 240, the digital code signals are converted to digital text signals by the main processing unit 322 according to the third table stored in a third memory area 329 of the main processing unit 322. The digital text signals are converted to text by the text processing unit 324. The text is displayed on the display screen 240 via the data bus 340 and the output interface 350. The user can then view the displayed text to confirm if the digital code signals such as the Morse Code signals are appropriately input or the second baseband signals are appropriately converted by the main processing unit 322.

If the sounds are output, the digital code signals are converted to digital audio signals by the main processing unit 322 according to the second table stored in the second memory area 328 of the main processing unit 322. The digital audio signals are converted to analog audio signals by the audio processing unit 324 and transmitted to the speakers. The speakers then output sounds according to the signals. The user can listen to the sounds to confirm if the digital code signals are appropriately input by the function keys 202 and 204 or the baseband signals are appropriately converted by the main processing unit 322. If the sounds are not correctly output, the user may re-enter the input using the function keys 202, 204 until the speaker 250 outputs the right sounds.

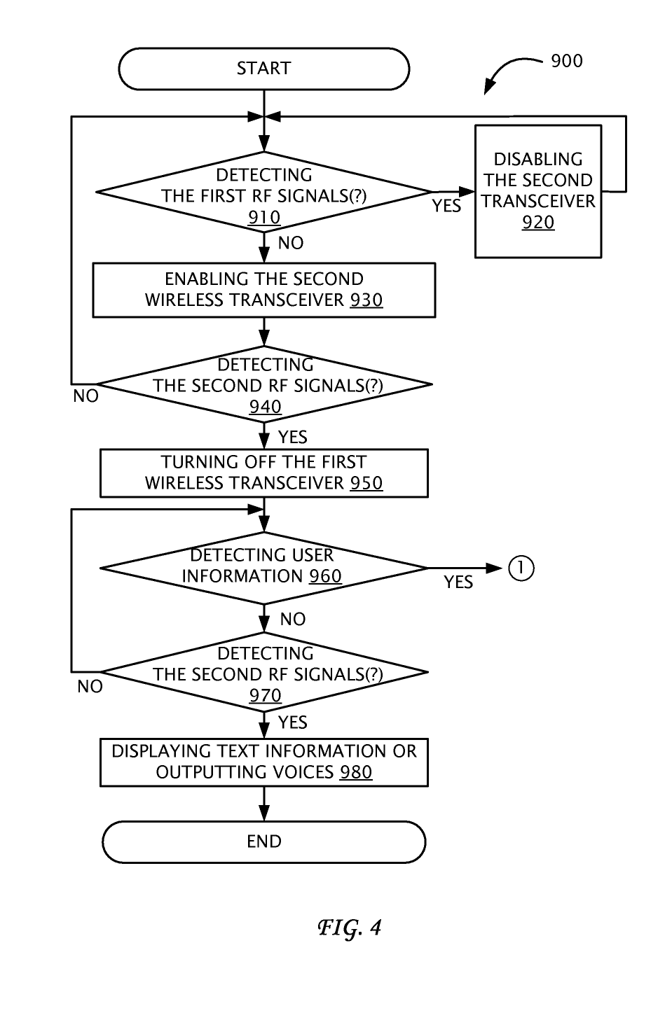

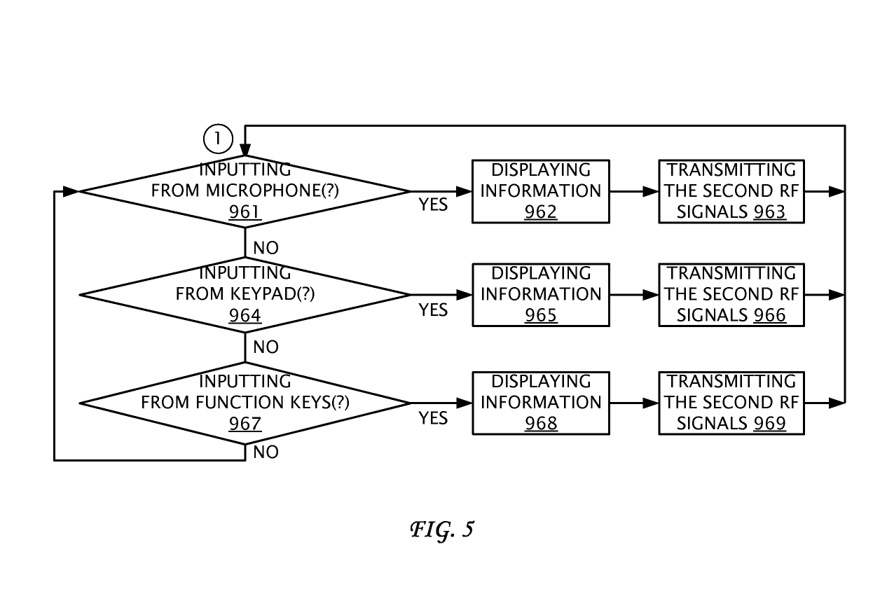

Referring to FIG. 4 and FIG. 5, a communication method 900 will be described. In some embodiments, the communication method 900, or portions thereof, may be performed by a handheld device 200 as described above, although the communication method 900 is not limited by the particular type of apparatus, software element, or system performing the communication method. The various actions in the communication method 900 may be performed in the order presented, or may be performed in a different order. Further, in some embodiments, some actions listed in FIG. 4 and FIG. 5 may be omitted from the communication method 900.

The method 900 commences at block 910, where the first RF waves or the first RF signals are detected. For example, the first antenna 210 receives the first RF waves and transfers the first RF signals to the first wireless transceiver 330. The first wireless transceiver 330 transforms the first RF signals to the first base-band signals that are transmitted to the base-band module 320. The first base-band signals are identified by a level transition from high to low at a first base-band signal input terminal of the base-band module 320, indicating that the first RF waves are detected.

At block 920, if the first RF waves or the first RF signals are detected, the second wireless transceiver 310 is disabled by the base-band module 320.

At block 930, if the first RF waves or the first RF signals are not detected, the second wireless transceiver 310 is enabled by the base-band module 320. For example, the first RF signal input terminal of the base-band module 320 has no level transition from high to low, indicating that the first RF waves or the first RF signals are not detected.

At block 940, an action is implemented for determining if the second RF waves or the second RF signals are detected. For example, the second antenna 220 receives the second RF waves and transfers the second RF signals to the second wireless transceiver 310. The second wireless transceiver 310 transforms the second RF signals to the second base-band signals that are transmitted to base-band module 320. The second base-band signals are identified by a level transition from high to low at a second RF signals input terminal of the base-band module 320, indicating that second RF waves or the second RF signals are detected.

If the second RF waves or signals are not detected, the procedure goes back to the block 910.

At block 950, if the second RF waves or the second RF signals are detected, the base-band module 320 the first wireless transceiver 310 is disabled for saving electrical energy.

At block 960, an action is implemented for determining if a user information is detected. More detail about the user information detecting process will be described hereinafter.

At block 970, an action is implemented for determining if the second RF waves or the second RF signals is detected. If the second RF waves or signals are not detected, the procedure goes back to the block 960.

At block 980, if the second RF signals are detected, the text information is displayed or the sounds are output. For example, the main processing unit 322 of the base-band module 320 finds the first table stored in the first memory area 327 to convert the second base-band signals into the digital audio signals. The digital audio signals are converted to analog audio signals by the audio processing unit 326. The speaker 230 outputs sounds corresponding to the analog audio signals.

Also, the main processing unit 322 may find the second table stored in the second memory area 328 to convert the second base-band signals into the digital text signals. The digital text signals are converted to text information by the text processing unit 324. The display screen 240 displays the text information.

More detail about the user information detecting process at the block 960 will be described.

At block 961, detecting whether the voices is input is determined. For example, if the voices are input from the microphone 260, the microphone 260 converts the voices to the analog audio signals. The analog audio signals are transferred to the audio processing unit 326 via the input interface 360 and the data bus 340.

At block 962, the display screen 240 displays the text information corresponding to the voices.

At block 963, the second RF signals are transmitted via the antenna 220.

At block 964, if the voices are not detected, detecting whether text is being inputted. For example, the text information is input from the keypad 250.

At block 965, the display screen 240 displays the text.

At block 966, the second RF signals are transformed to the second RF waves and transmitted via the antenna 220.

At block 967, if the text input is not detected, determining if the digital code signals (e.g., Morse code signals) are input. For example, the function keys 202, 204 are used for inputting the digital code signals (Morse code signals). The digital code signals are transferred to the main processing unit 322 via the input interface 360 and the data bus 340.

At block 968, the display screen 240 displays the text corresponding to the digital code signals.

At block 969, the second RF waves produced from the digital code signals are transmitted from the second antenna 220. The procedure goes back to the block 961 for the digital code signals are not detected.

As described above, the handheld device 200 and the communication method 900 thereof can be further used when the user encounters dangerous conditions, besides of performing the normal communication function. The second wireless transceiver is used to transmit the second RF waves. As the frequency of the second wireless RF signals is less than that in the CDMA or GSM standard. Such that the user may establish a wireless connection between the handheld device 200 and the rescuing center to request for aid when it is not possible for connecting the handheld device 200 to the BTS via the first RF waves.

Alternative embodiments will become apparent to those skilled in the art to which the present invention pertains without departing from its spirit and scope. For example, when the first RF signals are not detected by the base-band module 320, the first wireless transceiver 330 is disabled for saving electrical energy. If the second RF signals are not detected by the base-band module 320, the second wireless transceiver 310 is disabled for saving electrical energy.

What is claimed is:

1. A handheld device, comprising:
a first wireless transceiver using a first frequency for transmitting and receiving first radio frequency (RF) waves;
a second wireless transceiver using a second frequency lower than the first frequency, for transmitting and receiving second RF waves; and
a base-band module, the base-band module being electrically connected to the first wireless transceiver and the second wireless transceiver, the second wireless transceiver being disabled when the base-band module is able to transmit and/or receive the information via the first RF waves, the second wireless transceiver being enabled when the base-band module is able to transmit and/or receive the information via the second RF waves.

2. The handheld device as claimed in claim 1, wherein the first wireless transceiver is disabled when the second wireless transceiver is able to transmit and/or receive the information via the second RF waves.

3. The handheld device as claimed in claim 1, further comprising:
a microphone, the microphone configured to convert an audio input from a user to analog audio signals;
a speaker, the speaker configured to output sounds;
a keypad, the keypad configured to input text; and
a display screen, the display screen configured for displaying text.

4. The handheld device as claimed in claim 3, wherein the base-band module comprises:
a main processing unit, the main processing unit comprising a first read only memory area for storing a first table listing digital audio signals with corresponding encodings;
an audio processing unit electrically connected to the main processing unit, the audio processing unit receiving the audio input from the microphone and converting the audio input to audio signals, the main processing unit receiving the audio signals and converting the audio signals to a coded message according to the first table, the second wireless transceiver receiving the coded message and converting the coded message to the second RF signals.

5. The handheld device as claimed in claim 4, wherein the main processing unit further comprising:
a third read only memory area, the third memory area storing a third table of digital text message with corresponding encodings; and the base-band module further comprising:
a text processing unit, the text processing unit electrically connected to the main processing unit, the text processing unit receiving the text inputted via the keypad and converting the text to digital text signals, the main processing unit receiving the digital text signals and converting the digital text signals to coded message according to the third table, the second wireless transceiver receiving the coded message and converting the coded message to the second RF signals.

6. The handheld device as claimed in claim 4, wherein the processing unit further comprising:
a second read only memory area storing a second table of the digital audio signals and the corresponding digital text signals;
when the microphone is being used for inputting audio signals, the main processing unit converts the digital audio signals to digital text signals according to the second table, the text processing unit converting the digital text signals to text that is displayed on the display screen; and
when the keypad is being used for inputting a text message, the main processing unit converts the text to digital audio signals according to the second table, the audio processing unit converting the digital audio signals to analog audio signals that is processed by the speaker for outputting sounds.

7. The handheld device as claimed in claim 1, further comprising:
a plurality of function keys, the plurality of function keys are configured for inputting digital code signals, represented by Morse code, to the base-band module.

8. The handheld device as claimed in claim 1, wherein the second wireless transceiver comprises:
an antenna, the antenna configured for transmitting and receiving the second RF waves, down-converting the second RF waves to the second RF signals, and up-converting the second RF signals to the second RF waves.

9. The handheld device as claimed in claim 8, wherein the second wireless transceiver further comprises:
a switching unit, the switching unit is actuated for receiving and transmitting the second RF signals therefrom.

10. A communication method of a handheld device, the method comprising:
determining whether first radio frequency (RF) waves are being received by a first wireless transceiver;
enabling a second wireless transceiver for receiving the second RF waves if the first RF waves are not being received by the first wireless transceiver;
detecting whether user information being input to the handheld device; and
transmitting the second RF waves corresponding to the user information, being inputted to the handheld device, from the second wireless transceiver.

11. The communication method as claimed in claim 10, further comprising:
disabling the first wireless transceiver.

12. The communication method as claimed in claim 10, further comprising:
determining whether the second RF waves being received by the second wireless transceiver; and
displaying text corresponding to the second RF waves on a display screen of the handheld device for the second RF waves.

13. The communication method as claimed in claim 12, further comprising:
outputting sounds, corresponding to the second RF waves, from a speaker of the handheld device.

14. The communication method as claimed in claim 10, wherein detecting whether user information being input to the handheld device comprising:
detecting whether voices being inputted to the handheld device are from a microphone;
displaying the corresponding text of the inputted voices on a display screen.

15. The communication method as claimed in claim 10, wherein detecting whether user information being input to the handheld device comprising:
detecting whether text is being inputted from a keypad of the handheld device; and
outputting the corresponding sounds of the inputted text from a speaker of the handheld device.

16. The communication method as claimed in claim 10, wherein detecting whether user information being input to the handheld device comprising:
detecting whether digital code signals are being inputted from a plurality of function keys of the handheld device; and
displaying the corresponding text of the inputted digital code signals on a display screen of the handheld device.

17. The communication method as claimed in claim 16, further comprising:
outputting the corresponding sounds of the inputted digital code signals from a speaker of the handheld device.

18. The communication method as claimed in claim 17, wherein the digital code signals are represented by a dot and/or a dash.

19. The communication method as claimed in claim 18, wherein the dot and/or the dash represent Morse codes.
